(19) United States
(12) Patent Application Publication
(10) Pub. No.: US 2005/0251900 A1
(43) Pub. Date: Nov. 17, 2005

(54) Hazardous duty garments

(76) Inventor: John A. Harlacker, San Bernardino, CA (US)

Correspondence Address: LAW OFFICES OF TIMOTHY M. BARLOW, P.O. BOX 64775, TUCSON, AZ, 85728-4775, US

(21) Appl. No.: 11/012,562

(22) Filed: Dec. 15, 2004

Related U.S. Application Data
(60) Provisional application No. 60/571,594, filed on May 17, 2004.

(51) Int. Cl. A41D 1/00; A41D 13/00; A62B 17/00

(52) U.S. Cl. 2/457

(57) ABSTRACT

An improved hazardous duty garment system includes an abrasion-resistant, flame-resistant and heat-resistant outer shell, a moisture barrier attached inside the outer shell, and a thermal liner attached to the outer shell and the moisture barrier. The thermal liner includes at least one layer of thermal insulation attached to a layer of a metal screen thermal barrier. The metal screen layer may be made from a plurality of panels and fitted closely together, or a plurality of shingles. The metal screen panels are individually removable and replaceable. The metal screen provides superior heat dissipation properties and superior tolerance of direct heat.

### PRIORITY DATA

This application claims benefit of U.S. Provisional Patent Application Ser. No. 60/571,594 filed on May 17, 2004.

### BACKGROUND OF THE INVENTION

1. Field of the Invention

The present invention relates to protective garments. In particular, the present invention relates to improved protective garments for firefighters, foundry workers and other personnel in high-temperature environments.

2. Description of the Related Art

Workers in many professions are exposed to very hot and high temperature conditions. Even if the ambient temperatures are not excessive, momentary radiant heat levels can be extreme. In these conditions, unprotected flesh can be burned very quickly which creates an uncomfortable situation at best. At worst, high temperatures and extreme radiant heat can lead to incapacitation and death. Numerous safety devices and garments have been developed to deal with these adverse conditions.

Modern coats and pants are made of multiple layers of fire-resistant, water-resistant and abrasion-resistant materials. Of course, the abrasion-resistant layers are on the outside layer to protect the user and the garment from mechanical hazards and daily use. A water-resistant layer often is immediately under the top layer, to prevent the underlying thermal layers and the user from getting wet. Water-soaked material is a better thermal conductor than a dead air space.

Sometimes a semipermeable vapor barrier is used to release sweat vapor from the user so as not to saturate the thermal layers and preserve their thermal protective properties.

The thermal layers are made from one or more layers of material to provide a dead air space between the user and the external heat source to protect the user. Like most of the garments, the thermal layers are made from fire- and heat-resistant materials that will not burn or melt. However, they can still be destroyed through the application of direct heat.

Numerous garments and fabrics have been developed to minimize the risk posed to personnel in high heat environments. These include various types of coats, pants, pads, hoods and fabrics. Each of these types of garments found in the prior art has at least one major shortcoming. None of them can withstand the application of very high-temperature direct heat and extreme thermal radiation conditions such as would occur in a foundry.

Therefore, there has been and continues to be a need for a protective garment that gives an extra measure of safety in extreme, high-temperature environments.

### SUMMARY OF THE DISCLOSURE

An improved hazardous duty garment system includes an abrasion-resistant, flame-resistant and heat-resistant outer shell; a moisture barrier attached inside the outer shell; and a thermal liner attached inside the moisture barrier. The thermal liner includes at least one layer of thermal insulation attached to a layer of a metal screen thermal barrier. The metal screen thermal barrier provides superior heat dissipation properties and superior tolerance of direct heat and extreme heat radiation loads. The metal screen is made from iron, steel or other suitable metals with a high tolerance for heat. The metal screen can be galvanized of coated to provide additional protection and longevity. The metal screen thermal barrier can be made from a plurality of smaller panels to create a single layer, or can be arranged as shingles beneath the outer shell. The metal screen panels can be retained inside pockets or compartments of thermal insulation fabric to keep sharp edges contained and to make inspection and replacement of the metal screens a simple task.

It is therefore an object of the present invention to provide an improved hazardous duty garment which protects the wearer from very high temperature direct heat.

It is another object of the present invention to provide an improved hazardous duty garment which protects the wearer from extreme radiant heat loads.

It is another object of the present invention to provide an improved hazardous duty garment for firefighters.

It is yet another object of the present invention to provide an improved hazardous duty garment for foundry workers.

It is yet a further object of the present invention to provide an improved hazardous duty garment which is flexible and permits free movement of the wearer.

It is yet another object of the present invention to provide an improved hazardous duty garment where the heat and radiation barriers are easily inspected.

It is yet another object of the present invention to provide an improved hazardous duty garment where the heat and radiation panels are easily replaced.

Finally, it is an object of the present invention to accomplish the foregoing objectives in a simple and cost effective manner.

### BRIEF DESCRIPTION OF THE DRAWINGS

FIG. 1 is a front view of a preferred embodiment of the improved hazardous duty garment in accordance with the present invention;

FIG. 2 is a rear view of an alternate embodiment of the improved hazardous duty garment in accordance with the present invention;

FIG. 3 is a side view of an alternate embodiment of the improved hazardous duty garment in accordance with the present invention;

FIG. 4 is a front view of a preferred embodiment of the improved hazardous duty garment in accordance with the present invention;

FIG. 5 is a rear view of a preferred embodiment of the improved hazardous duty garment in accordance with the present invention;

FIG. 6 is a perspective view of a hazardous duty face mask in accordance with the present invention;

FIGS. 7A and 7B are perspective views of a pair of hazardous duty gloves in accordance with the present invention;

FIG. 8 is a perspective view of a hazardous legging in accordance with the present invention;

FIG. 9 is a perspective view of a hazardous duty boot in accordance with the present invention; and

FIG. 10 is a side view of a hazardous duty fire blanket in accordance with the present invention.

### DETAILED DESCRIPTION OF THE PREFERRED EMBODIMENT

The following detailed description is of the best presently contemplated modes of carrying out the invention. This description is not to be taken in a limiting sense, but is made merely for the purpose of illustrating general principles of embodiments of the invention.

The present invention provides an improved hazardous duty garment for protecting the user from high temperatures and extremely high radiant heat conditions. Externally, the garment is similar in many ways to existing garments currently manufactured, but this garment includes a metal screen heat barrier beneath the outer shell of the garment. The metal screen acts as a barrier to dissipate high temperature and extreme high radiant heat loads. It is virtually impervious to high temperatures experienced by firefighters and will not break down and degrade like more common fire-resistant fabrics and fibers.

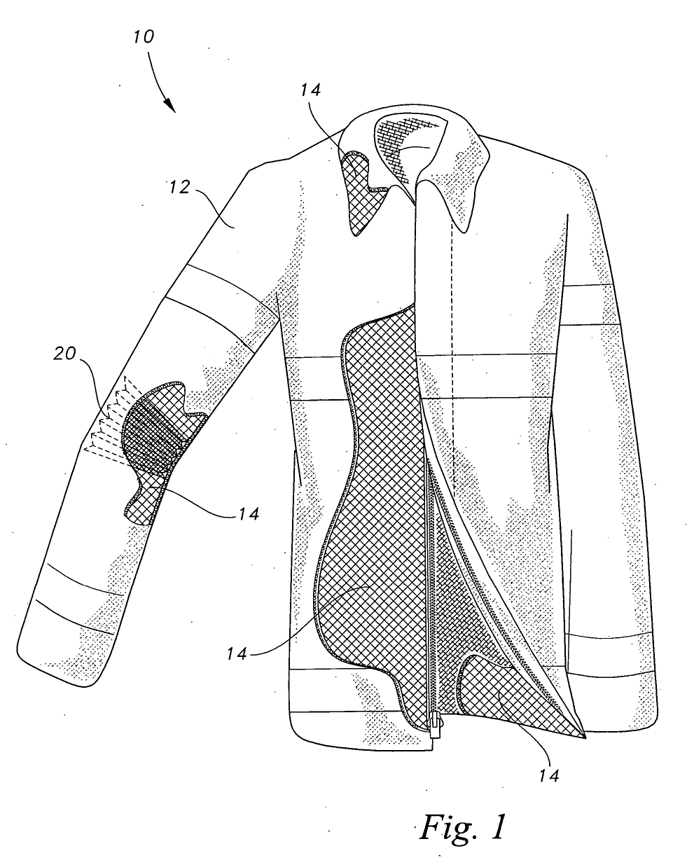

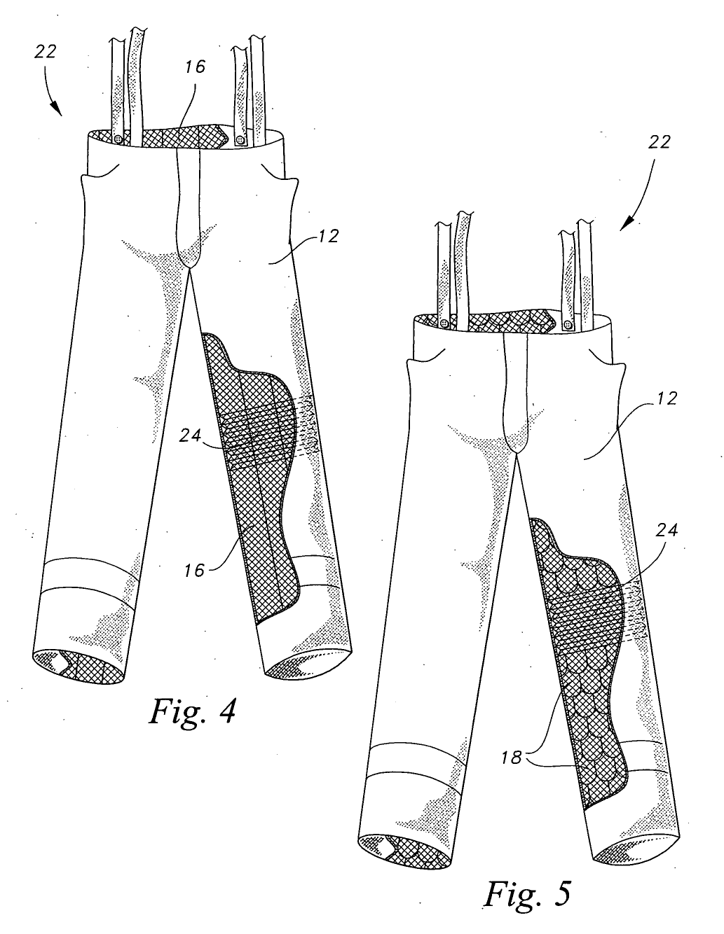

FIGS. 1-5 show different embodiments of the hazardous duty garments. FIGS. 1-3 show a coat 10 and FIGS. 4-5 pants or coveralls 22. These garments all have several features in common. The top layer of the garments is a tough, water-resistant, abrasion-resistant, heat-resistant shell 12. A moisture barrier is attached inside the outer shell 12 to protect the garment from becoming saturated with water and excessively heavy, and to prevent water damage to the underlying insulation layer. The shell 12 covers the insulating layers that are worn closest to the user. The insulating layers include at least one layer of a typical thermal insulation material, such as Nomex® or similar material. In addition, the insulating layer includes a layer of metal screen 14. The screen 14 acts as a heat barrier to afford greater protection to the user. The screen 14 has heat-reflecting and heat-dissipating properties that provide protection beyond that offered by typical garments. The screen 14 is made from a metal with a high tolerance for heat and with good flexibility, such as steel, bronze or brass. Where water is frequently encountered, the screen may be a material that is not prone to rusting or oxidizing. Materials may be selected for use in various applications depending on their physical and chemical properties and their suitability for a particular task or environment. The screen 14 may be coated for greater corrosion protection. Bronze, brass, galvanized steel and black-coated screen satisfy these purposes, but any number of other combinations could be used successfully. Other considerations for the screen include flexibility, availability and cost. In other embodiments, the screen 14 is a welded or woven wire mesh, perforated metal sheet, expanded metal sheet or metallic film. Such materials need to be flexible and with a fine mesh to minimize direct heat and radiant heat transmission. Another embodiment is an opaque metallic film that eliminates the mesh holes entirely, and is protected under the shell 12.

FIG. 1 shows a coat 10 with a single layer of screen 14 incorporated into the torso and sleeves of the coat 10. In the preferred embodiment, the screen 14 is sandwiched between layers of thermal insulation material (not shown). The screen 14 shown is a single, continuous piece that is shaped and formed into a torso shape. At the shoulders, the sleeves are attached to the torso so that the sleeve screens overlap the torso screen slightly, to eliminate any thermally-compromised areas. In one embodiment, the sleeves include a pre-bent, pleated elbow section 20. The pleated elbow 20 enables the user to don the coat and use it immediately without encumbrance. The pleated elbow 20 affords a consistent location for the sleeves to flex, distributing the area for movement, and minimizing the fatigue and breakage of the screen panels in the sleeves. The shoulders may include a pleated area for ease of movement. If desired, the arm pits may omit the metal screen due to the protection afforded to this area by the outer arm and shoulder.

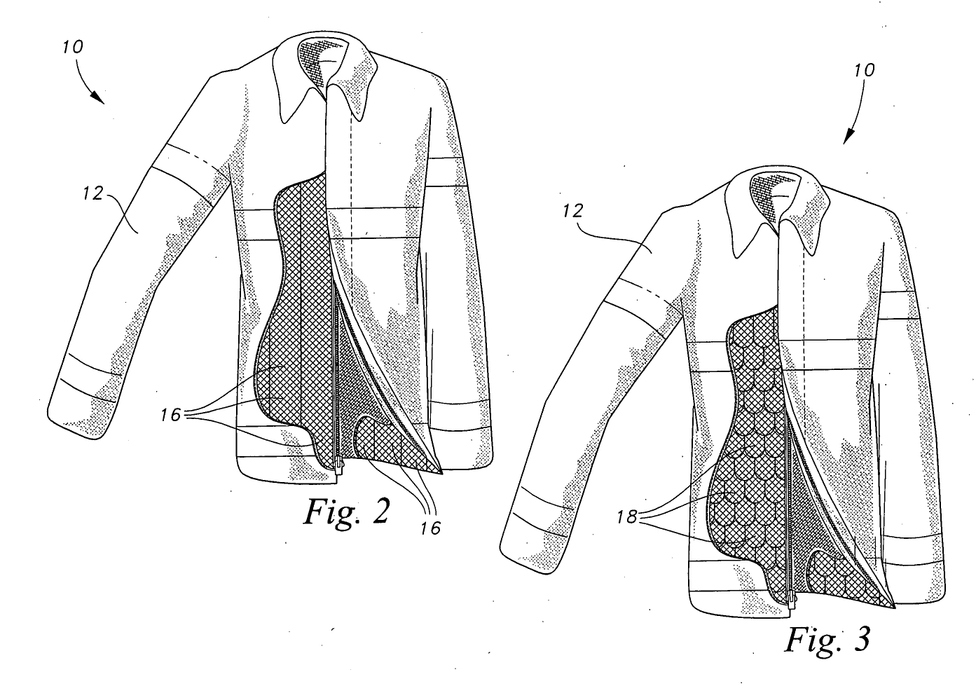

FIG. 2 shows a coat 10 that uses multiple, smaller screen panels 16 instead of a single panel. Again, the multiple screen panels 16 are sandwiched between layers of thermal insulation beneath the shell 12. In one embodiment, the multiple screen panels 16 are vertically oriented within the torso of the coat 10. This is shown in FIG. 2. In another embodiment, the multiple screen panels 16 are horizontally oriented in the torso of the coat 10. Like the single panel shown in FIG. 1, the multiple panels 16 are sandwiched between layers of thermal insulation material. The multiple screen panels 16 provide an advantage to the manufacturer by making it easier to assemble a coat 10 than if a single panel 14 were used. The multiple screen panels 16 also provide an advantage in that they are easier to replace. A single, smaller screen panel can be removed from the thermal insulating liner and inspected or replaced as necessary. The thermal insulation liner can be constructed with individual pockets to accept and retain the individual screen panels that make up the multiple screen panels 16.

FIG. 3 shows another embodiment of the coat 10. This coat 10 uses a large number of smaller shingle screen panels 18. The shingle screen panels 18 are arranged throughout the coat 10 like roofing shingles or the scales on a fish. Like roofing shingles, these single screens 18 afford a relatively large area of overlap to increase the protection to the user and to improve mobility and flexibility. Like the aforementioned embodiments, the shingle screen panels 18 are sandwiched between layers of thermal insulation material. The shingle screen panels 18 also provide an advantage in that they are easier to replace. A single, smaller shingle screen panel 18 can be removed from the thermal insulation liner and inspected or replaced as necessary. The thermal insulation liner can be constructed with individual pockets to accept and retain the individual shingle screen panels 18.

FIGS. 4 and 5 show a coverall or pants 22 for hazardous duty. FIG. 4 shows pants 22 that uses multiple, smaller screen panels 16 instead of a single panel. As in the aforementioned coats 10, the multiple screen panels 16 are sandwiched between layers of thermal insulation beneath the shell 12. In the preferred embodiment, the multiple screen panels 16 are vertically oriented along the legs of the pants 22. The multiple screen panels 16 are sandwiched between layers of thermal insulation material. The multiple screen panels 16 provide an advantage to the manufacturer by making it easier to assemble hazardous duty garments than if a single panel 14 were used. The multiple screen panels 16 also provide an advantage in that they are easier to replace. A single, smaller screen panel can be removed from the thermal insulating liner and inspected or replaced as necessary. The thermal insulation liner can be constructed with individual pockets to accept and retain the individual screen panels that make up the multiple screen panels 16. In one embodiment, the legs include a pre-bent, pleated knee section 24. The pleated knee 24 enables the user to don the pants 22 and use it immediately without undue encumbrance. The pleated knee 24 affords a consistent location for the legs to flex, distributing the area for movement, and minimizing the fatigue and breakage of the screen panels in the legs of the pants 22.

In FIG. 5 the pants 22 use a large number of smaller shingle screen panels 18. The shingle screen panels 18 are arranged throughout the pants 22 like roofing shingles or the scales on a fish. Like roofing shingles, these single screens 18 afford a relatively large area of overlap to increase the protection to the user and to improve mobility and flexibility. Like the aforementioned embodiments, the shingle screen panels 18 are sandwiched between layers of thermal insulation material. The shingle screen panels 18 also provide an advantage in that they are easier to replace. A single, smaller shingle screen panel 18 can be removed from the thermal insulation liner and inspected or replaced as necessary. The thermal insulation liner can be constructed with individual pockets to accept and retain the individual shingle screen panels 18.

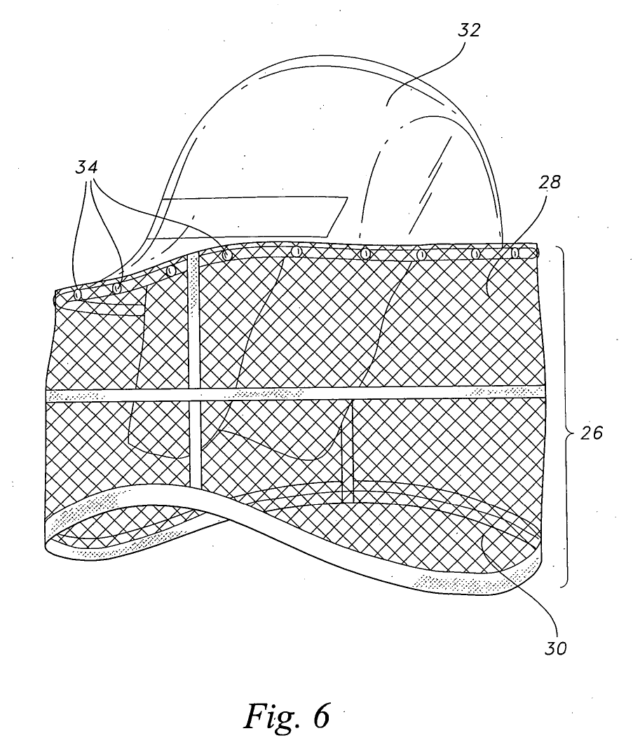

FIG. 6 shows a hazardous duty face mask 26 that incorporates the metal screen technology. The face mask 26 is shown mounted to a helmet 32 for a firefighter. The face mask 26 has a layer of screen that is attached to the helmet 32 with a plurality of fasteners 34. The fasteners 34 may be metal snaps or any other material possessing similar heat-proof and heat-resistant properties as the helmet 32 and face mask 26. The face mask 26 extends downward from the brim of the helmet 32 below the wearer's chin and neck to offer more complete coverage of the wearer, especially when worn with matching pants and coat as described above. The metal screen face mask provides the wearer protection from high temperatures and extremely high radiant heat conditions. The face mask 26 may be made from two separate panels, an upper screen 28 and a lower screen 30 to permit the manufacturer to tailor the heat protection and light-transmission properties to suit the user. For example, the upper screen 28 may include a more open, less protective screen, particularly in front of the eyes, to minimize the face mask's effect on vision. Other areas of the face mask 26 may include a more opaque, less transmissive screen, or multiple layers of screen, to maximize heat protection. The face mask 26 may be made from one or more layers in its entirety or selectively, depending upon the protective properties desired by the user. In another embodiment, the face mask upper screen 28 may be further subdivided into smaller units. For example, an eye shield (not shown) may protect the area immediately in front of the eyes, but may also be pivotally attached to the helmet 32. In such an embodiment the user could flip the eye shield up or down to allow a better view of his work, but flipped down to protect the user's eyes. The face mask upper screen 28, or any other movable panels, may be removably attached to the helmet 32 or other parts of the face mask 26 for maximum protection with minimal inconvenience. A frame (not shown) may be included to provide support and shape to the lower parts of the face mask 26 around the user's neck and shoulders, around the center of the face mask 26 or around the helmet's 32 brim. The lower screen 30 may include a dust mask (not shown) or filter to reduce airborne irritants.

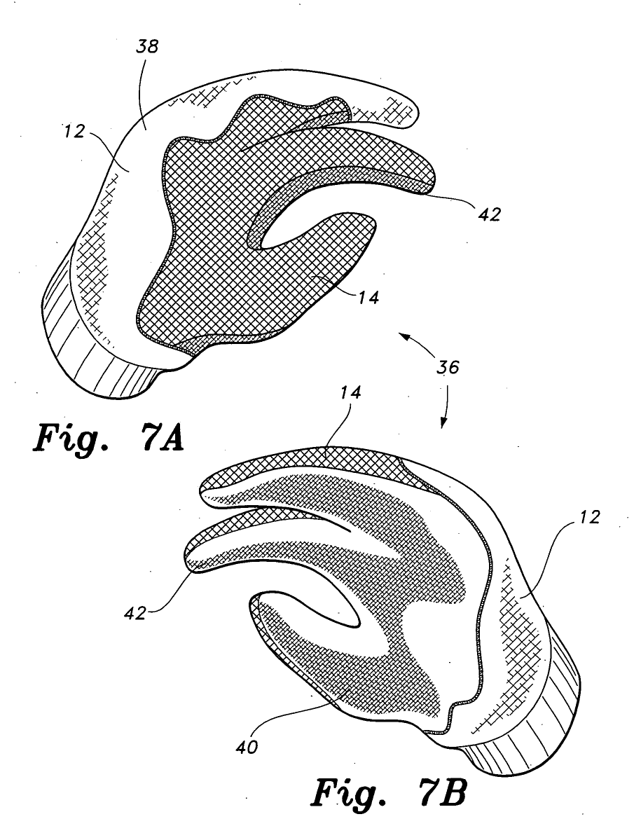

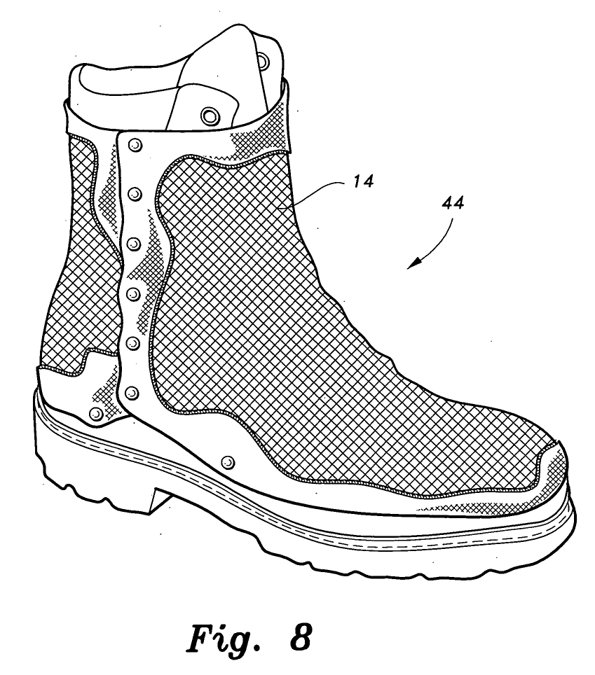

FIGS. 7A and 7B are perspective views of hazardous duty gloves 36 in accordance with the present invention. FIG. 7A shows that the back 38 of the glove 36 includes a layer of metal screen mesh 14 beneath a layer of heat- and fire-resistant material 12. The metal screen 14 provides an extra measure of protection for the parts of the hands that are most exposed to high temperature and thermal radiation conditions. The palm 40 of the glove 36 shown in FIG. 7B does not have any metal screen 14. Omitting the metal screen 14 in the palm 40 serves to improve the flexibility and usefulness of the glove 36, without compromising the protection for the wearer. The gloves 36 may be made with five digits or with a lesser number 42, as shown. The lesser number of digits 42 affects manual dexterity to some degree, but improves the protection to the fingers.

FIG. 8 is a perspective view of a hazardous legging 44 in accordance with the present invention. The legging 44 is a layer of metal screen 14 beneath a layer of heat- and fire-resistant material 12. The legging 44 is worn around the lower part of the leg and may cover the top of the boots as well. The legging 44 is shown extending up to the top of the boot, but in another embodiment, the legging 44 extends up around the wearer's calf, below the knee. The legging 44 affords protection to the ankle and lower leg that may not be adequately covered by the hazardous duty pants 22 or coveralls. A strap (not shown) may routed beneath the boot sole in front of the heel, to hold the legging 44 down in place atop the boot.

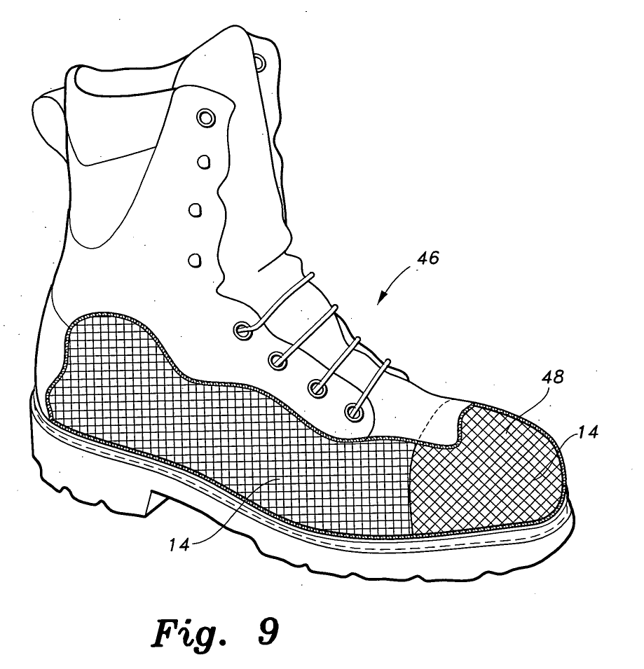

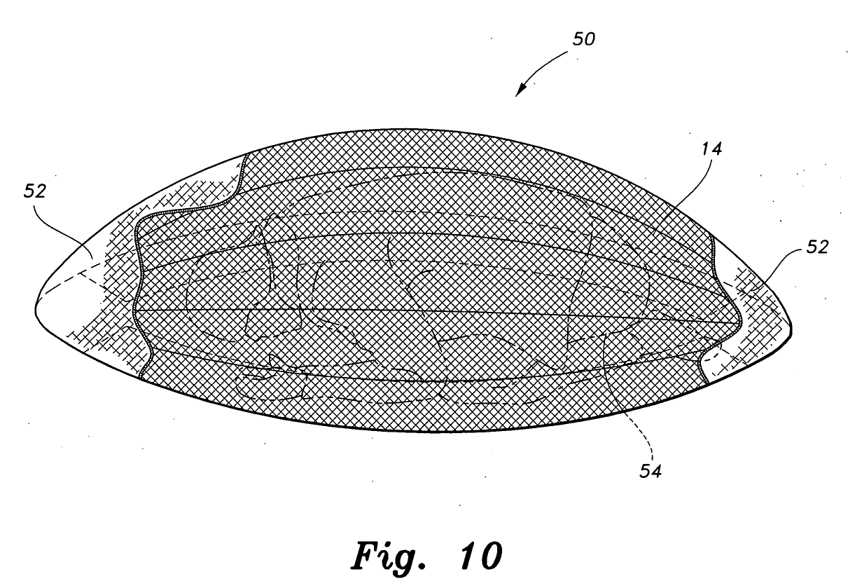

FIG. 9 is a perspective view of a hazardous duty boot 46 in accordance with the present invention. The boot 46 shown has a layer of metal screen 14 immediately below the outer layer of the boot 46. The outer layer may be leather or another material suitable for hazardous duty use. A layer of screen 14 may be included between the sole and the insole as well. The screen 14 is a flexible mesh that provides heat protection without compromising flexibility and usefulness. Boots 46 having a steel toe 48 provide a built-in hot spot for many boots 46. Another layer of screen may be used at the toe if the boot 46 has a steel toe 48. The extra layer of screen does not affect flexibility at all since the steel toe 48 does not flex.

FIG. 10 is a side view of a hazardous duty fire shelter 50 in accordance with the present invention. This shelter 50 is a combination tent and blanket and has an aluminized fabric outer layer 52 for maximum heat reflectivity in a useful, rugged package. The firefighter 54 crouches beneath the shelter 50 and holds the edges down with his feet, knees, elbows and hands. However, in a situation where a firefighter 54 cannot escape the flames, such as in a forest fire, the firefighter 54 often needs more protection. Despite the protection from the aluminized fabric 52, the temperature quickly becomes unbearable under the shelter 50. Standard gloves and boots become singed or badly damaged. Fingers and toes are often burned. A layer of lightweight, flexible metal screen 14 attached beneath the aluminized material 52 provides an extra measure of protection and a few extra minutes of relative comfort.

While the description above refers to particular embodiments of the present invention, it will be understood that many modifications may be made without departing from the spirit thereof. The accompanying claims are intended to cover such modifications as would fall within the true scope and spirit of the present invention.

Element List

10 hazardous duty coat
12 shell
14 screen layer
16 multiple screen panels
18 shingle screen panels
20 pleated elbow
22 pants
24 pleated knee
26 face mask
28 upper screen
30 lower screen
32 helmet
34 fasteners
36 glove
38 back
40 palm
42 fingers
44 legging
46 boot
48 steel toe
50 shelter
52 aluminized material
54 firefighter

1. An improved hazardous duty garment system, comprising:
an abrasion-resistant, flame-resistant and heat-resistant outer shell;
a moisture barrier attached inside the outer shell; and
a thermal liner comprising at least one layer of thermal insulation attached to a layer of a metal screen thermal barrier.

2. The improved hazardous duty garment system as set forth in claim 1, where the layer of metal screen is sandwiched between two or more layers of thermal insulation.

3. The improved hazardous duty garment system as set forth in claim 1, where the layer of metal screen is comprised of a plurality of panels.

4. The improved hazardous duty garment system as set forth in claim 3, where the garment is a coat having a torso component and a pair of sleeves.

5. The improved hazardous duty garment system as set forth in claim 3, where the garment is a pair of pants having a pair of legs.

6. The improved hazardous duty garment system as set forth in claim 4, where the plurality of panels comprises a plurality of generally rectangular panels body panels oriented horizontally around the torso of the coat, and a plurality of sleeve panels oriented substantially parallel to the orientation of the sleeves.

7. The improved hazardous duty garment system as set forth in claim 6, where the sleeve panels further comprise a formed, pre-bent elbow.

8. The improved hazardous duty garment system as set forth in claim 5, where the plurality of panels comprises a plurality of generally rectangular leg panels oriented vertically in the legs of the pants.

9. The improved hazardous duty garment system as set forth in claim 8, where the leg panels further comprise a formed, pre-bent knee.

10. The improved hazardous duty garment system as set forth in claim 3, where the plurality of panels are each individually replaceable.

11. The improved hazardous duty garment system as set forth in claim 3, where the plurality of panels are arrayed in an overlapping shingle pattern.

12. The improved hazardous duty garment system as set forth in claim 1, where the metal screen comprises a woven wire mesh.

13. The improved hazardous duty garment system as set forth in claim 1, where the metal screen comprises a welded wire mesh.

14. The improved hazardous duty garment system as set forth in claim 1, where the metal screen comprises a perforated metal sheet.

15. The improved hazardous duty garment system as set forth in claim 1, where the metal screen comprises an expanded metal sheet.

16. The improved hazardous duty garment system as set forth in claim 1, where the metal screen is galvanized.

17. The improved hazardous duty garment system as set forth in claim 1, where the metal screen is coated with a water- and heat-resistant coating.

18. The improved hazardous duty garment system as set forth in claim 1, where the metal screen is a very fine mesh that is opaque to light.

19. The improved hazardous duty garment system as set forth in claim 1, where the metal screen is a metallic film.

20. The improved hazardous duty garment system as set forth in claim 1, where the thermal liner is removable for inspection, repair and cleaning.

21. An improved hazardous duty garment system, comprising:
an abrasion-resistant, flame-resistant and heat-resistant outer shell;
a moisture barrier attached inside the outer shell; and
a metal screen heat barrier sandwiched within a thermal liner, the thermal liner comprising two or more layers of thermal insulation, the metal screen heat barrier being comprised of a plurality of panels.

22. The improved hazardous duty garment system of claim 21, where the metal screen heat barrier comprises a plurality of panels arranged in an overlapping shingle pattern.

23. An improved hazardous duty helmet system, comprising:
a metal-screen face mask attached to a helmet, where the face mask protects the wearer's face from high direct- and radiant-heat sources.

24. The improved hazardous-duty helmet system of claim 23, where the face mask further comprises a plurality of metal screen panels.

25. The improved hazardous-duty helmet system of claim 23, where the face mask encircles the entire helmet and the wearer's head.

26. The improved hazardous-duty helmet system of claim 23, where the face mask is comprised of two or more layers of metal screen.

27. An improved hazardous-duty shelter, comprising:
a layer of reflective fabric; and
a layer of metal screen attached to the reflective fabric.

28. The improved hazardous-duty shelter of claim 27, where the reflective fabric further comprises a layer of aluminized material.
